(19) United States
(12) Patent Application Publication
(10) Pub. No.: US 2009/0056354 A1
(43) Pub. Date: Mar. 5, 2009

(54) Refrigeration power system for a storage compartment in a vehicle

(76) Inventors: Scott Judson Davis, Kalamazoo, MI (US); Joseph Michael Kaczmar, Mattawan, MI (US); Michael Andrew Roussin, Three Rivers, MI (US)

Correspondence Address: FLYNN THIEL BOUTELL & TANIS, P.C., 2026 RAMBLING ROAD, KALAMAZOO, MI, 49008-1631, US

(21) Appl. No.: 12/229,283

(22) Filed: Aug. 21, 2008

Related U.S. Application Data
(60) Provisional application No. 60/966,803, filed on Aug. 30, 2007.

(51) Int. Cl. F25B 27/00; F25B 1/00; B60H 1/32; G05D 23/00

(52) U.S. Cl. 62/236; 62/498; 62/228.4; 62/241; 700/300

(57) ABSTRACT

A refrigeration power system for cooling a storage compartment in a vehicle includes a power source independent of a vehicle battery. The power source provides power to a refrigeration unit that includes a variable speed compressor. The refrigeration power system determines available power and varies the speed of the compressor accordingly to provide a lesser amount of cooling at start-up or when the available power value is less than a required power value. The power system operates the variable speed compressor at the required power value when the available power value is large enough to provide a cooling capacity so that the storage compartment obtains a pre-selected temperature. Power sources, and alternate power sources, include a vehicle generator, a shore power supply, a battery bank and a vehicle battery provided on the vehicle.

### CROSS-REFERENCE TO RELATED APPLICATION

This application claims the benefit of U.S. Provisional Application No. 60/966803, filed Aug. 30, 2007.

### FIELD OF THE INVENTION

This invention generally relates to a power system for a refrigeration unit in a vehicle, and more particularly to a power system for a refrigeration unit including a variable speed compressor for changing the amount of cooling provided to a storage compartment depending on available electric power.

### BACKGROUND OF THE INVENTION

Refrigeration units for storage compartments on trucks are utilized extensively for the transport of goods, such as fresh and frozen food, requiring refrigeration or freezer temperatures. These units are also sometimes heated to keep produce from freezing, using electric heaters. In the U.S., the majority of the refrigeration units on trucks are powered by a diesel engine that is separate from the vehicle engine. In some instances, an electric motor is provided as a back-up system that can operate the refrigeration unit when the truck is parked and shore power from a stationary source, such as an electrical outlet, is available.

Some known truck refrigeration units are electrically powered by a battery or operate off of the electricity produced by a truck generator, but are limited by a number of factors. First, most generators powered by a truck engine are very limited in their power producing capabilities. Secondly, electrical refrigeration units require a substantially higher electrical load to start operating, which is typically as high as 8 to 10 times the power required to provide cooling under normal conditions. Another operational consideration is that the amount of power produced by an engine powered generator varies according to the engine speed. As a result, when a truck is stopped or is at engine idle, the amount of available power is substantially reduced. In a truck, a normal refrigeration system is maximized to operate at one speed for full power and full cooling capacity. Such a truck refrigeration unit normally cannot continue to function with reduced power.

One object of the invention is to provide a refrigeration power system for cooling a vehicle storage compartment that can operate with a low amount of electric power and start up with a lower amount of power to provide a minimum cooling capacity and that can then operate, after the refrigeration unit becomes efficient, at a greater cooling capacity with the same amount of power.

Another object of the invention is to provide cooling under low power conditions whereat a conventional truck refrigeration unit does not operate.

### SUMMARY OF THE INVENTION

The objects and purposes of the invention are met by providing a vehicle with a refrigeration power system that makes maximum use of available power and provides the most refrigeration cooling capacity possible for the available power value.

In one embodiment of the invention the refrigeration power system provides for a low power requirement on engine start up to provide minimal cooling, and then dynamically allows adjustment of compressor speed for additional cooling as the refrigeration unit becomes more efficient, due to cooling down of the storage compartment.

In another embodiment of the invention, the power system allows for variations in the power level, for example when the vehicle is at engine idle condition, by reading the power available and adjusting the amount of refrigeration cooling capacity to the available power level.

In another embodiment of the invention, the variable speed compressor is controlled to provide a pre-selected temperature in the storage compartment. Since the refrigeration unit is designed for operating the compressor at a maximum frequency, when the compressor speed is reduced the efficiency of the refrigeration unit increases due to the condenser and evaporator having a greater size than necessary for the reduced compressor output.

### BRIEF DESCRIPTION OF THE DRAWINGS

FIG. 1 is a perspective partial view of a vehicle including a refrigeration unit embodying the invention;

FIG. 2 is a block diagram of a refrigeration power control arrangement according to the invention;

FIG. 3 shows the operating frequency range and cooling capacity for the variable speed compressor according to the invention;

FIG. 4 is a flow chart showing operation of the invention;

FIG. 5 is a block diagram of a refrigeration power control arrangement according to the invention; and

FIG. 6 is a flow chart showing operation of the FIG. 5 embodiment of the invention.

Certain terminology will be used in the following description for convenience in reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the system and designated parts thereof. Said terminology will include the words specifically mentioned, derivatives thereof, and words of similar import.

### DETAILED DESCRIPTION OF DRAWINGS

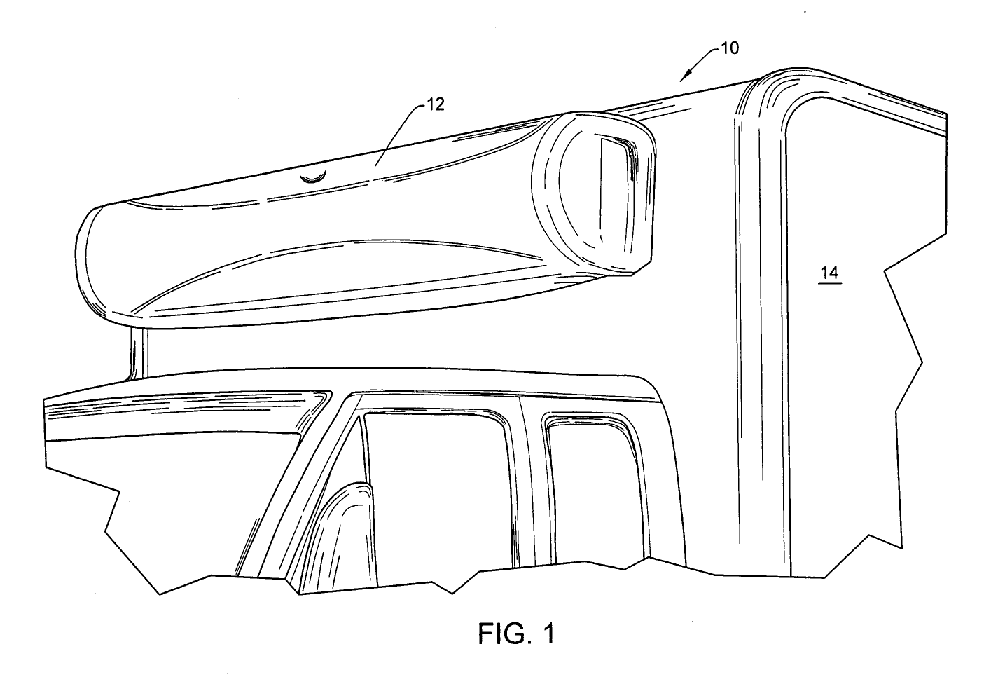

FIG. 1 illustrates a vehicle 10 having a refrigeration cooling unit 12 according to the invention mounted thereon. The vehicle includes a storage compartment 14 for receiving goods that need to be maintained pre-selected temperature.

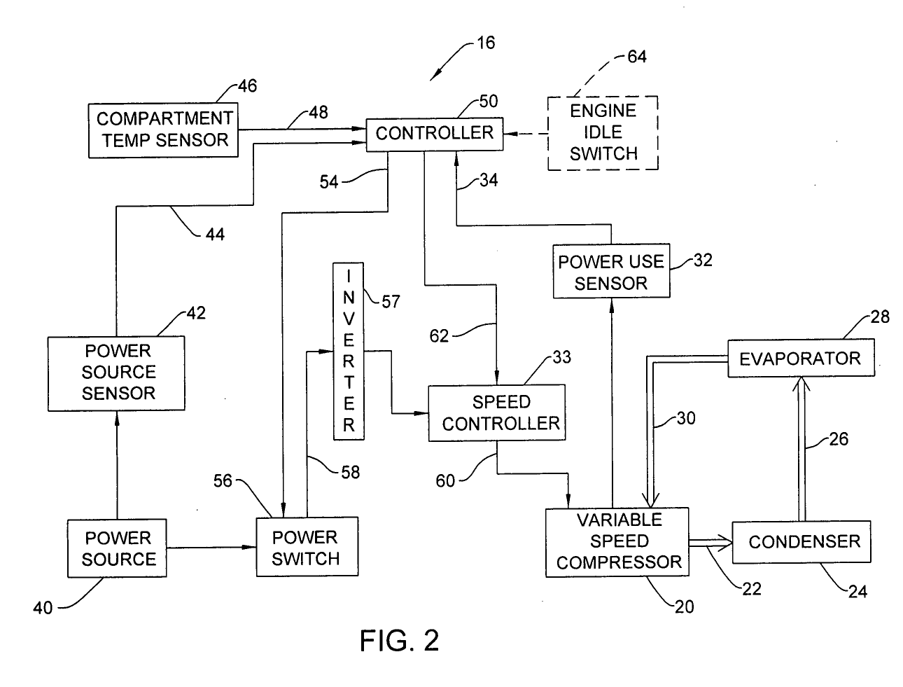

The refrigeration power control arrangement 16 shown in FIG. 2 includes a variable speed compressor 20 that has an output port connected through a first flow passage 22 to an input port of a condenser 24. An output port of the condenser 24 then connects via a second flow passage 26 to an input port of an evaporator 28. An output port of the evaporator 28 connects through a flow passage 30 to a suction input of the variable speed compressor 20. The refrigeration unit 12 including the compressor 20, condenser 24 and evaporator 28 are provided with high and low pressure switches, a hot gas regulator, an oil separator and other elements known in the art in order to properly function as a refrigeration cooling system. For example, the condenser 24 and evaporator 26 are provided with fans (not shown).

The compressor 20 includes an electric powered AC synchronous compressor motor that drives lubricating oil and refrigerant through the condenser 24 and evaporator 28 in a known manner. The compressor motor of the variable speed compressor 20 rotates a compressor shaft at various speeds depending on its operating frequency.

FIG. 2 shows a power use sensor 32 that senses the power being used by the variable speed compressor 20 and outputs a power in use signal 34. The power in use signal 34 from the power use sensor 32 indicates the amount of power currently being provided to operate the refrigeration unit 12. In some embodiments, the power use sensor 32 is part of a speed controller 33 that controls the speed of the compressor 20. In some embodiments, the power in use signal 34 includes the power provided to operate valves, the evaporator and condenser fans, and other elements of the refrigeration unit 12.

The speed controller 33 provides a signal to the AC motor of the variable speed compressor 20 to control the speed thereof and/or provides a signal to the inverter 57 to control the power provided to the AC motor of the compressor 20. In some embodiments the speed controller 33 also receives the power from the inverter 57 and controls the power to the AC motor of the compressor 20 as shown in FIG. 2.

FIG. 2 shows a power source 40 that is capable of outputting different values of power depending on various conditions. A power source sensor 42 connected to the power source 40 determines an available power value for the power source 40 and provides an available electric power value signal 44. In some embodiments, the power source sensor 42 is integral with or a part of the power source 40.

The refrigeration power control arrangement 16 shown in FIG. 2 includes a compartment temperature sensor 46 that measures the temperature in the storage compartment 14 and provides a compartment temperature signal 48.

A power system controller 50 is provided by a PLC, microprocessor or other decision circuit device. The controller 50 receives the available electric power value signal 44 and receives the compartment temperature signal 48. Further, the power use sensor 32 provides the power in use output signal 34 corresponding to the power currently used to drive the AC synchronous compressor motor of the compressor 20 to the controller 50.

The controller 50 is configured to output a power supply signal 54 to a power switch 56. The power switch 56 typically is a solid state circuit that allows power flow therethrough when enabled by the power supply signal 54. When activated, the power switch 56 sends AC power derived from the power source 40 by an inverter 57 to the variable speed compressor 20 via power carrying lines 58, 60. Further, the controller 50 includes an output for a compressor speed control signal 62.

The additional elements illustrated in dashed line in FIG. 2 represent another embodiment of the invention that includes an engine idle switch 64 for providing an engine idle on signal to the controller 50.

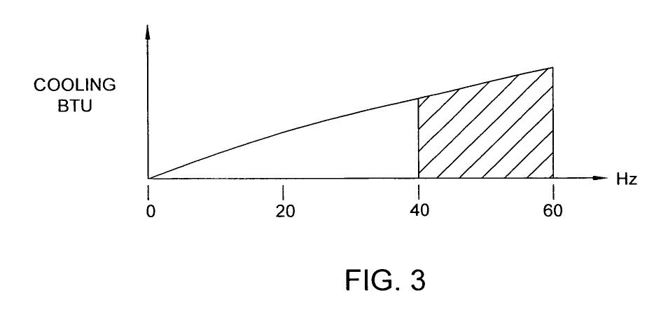

FIG. 3 is an operational curve of the variable speed compressor 20 showing cooling capacity (BTUs) versus compressor speed. As shown in FIG. 3, the variable speed compressor 20 begins providing a cooling output through the condenser 24 and evaporator 28 of the refrigeration unit 12 when operated at a frequency of about 40 Hz. When the variable speed compressor 20 is operated at greater frequencies the cooling capacity increases as illustrated in the FIG. 3. The speed of operation for the asynchronous electric compressor motor of the compressor 20 is proportional to the magnitude of the compressor speed control signal 62. The asynchronous electric motor has a maximum frequency of about 60 Hz. At 40 Hz, the variable speed compressor 20 provides about 2,000 revolutions per minute (rpm) for a compressor motor shaft that compresses the lubricating oil and the refrigerant, and at 60 Hz the compressor motor shaft provides about 3,500 rpm.

The operating range shown in FIG. 3 for the variable speed compressor 20 enables the asynchronous motor of the compressor 20 to start up and operate with a lesser input power, instead of starting up operating at full power. The difference between a fixed refrigeration cooling capacity and the dynamically adjusted greater capacity shown at 40 Hz and 60 Hz in FIG. 3 can be 15%. Further, the operating range shown in FIG. 3 allows the variable speed compressor 20, and thus the refrigeration unit 12, to provide various dynamic cooling capacities as necessary to maintain the temperature in the storage compartment 14 at a pre-selected temperature or to provide at least minimal cooling to the storage compartment 14 when the available power value is not adequate to provide complete desired cooling to the storage compartment. These operations are explained in detail below as follows.

### Operation of Refrigeration Power System

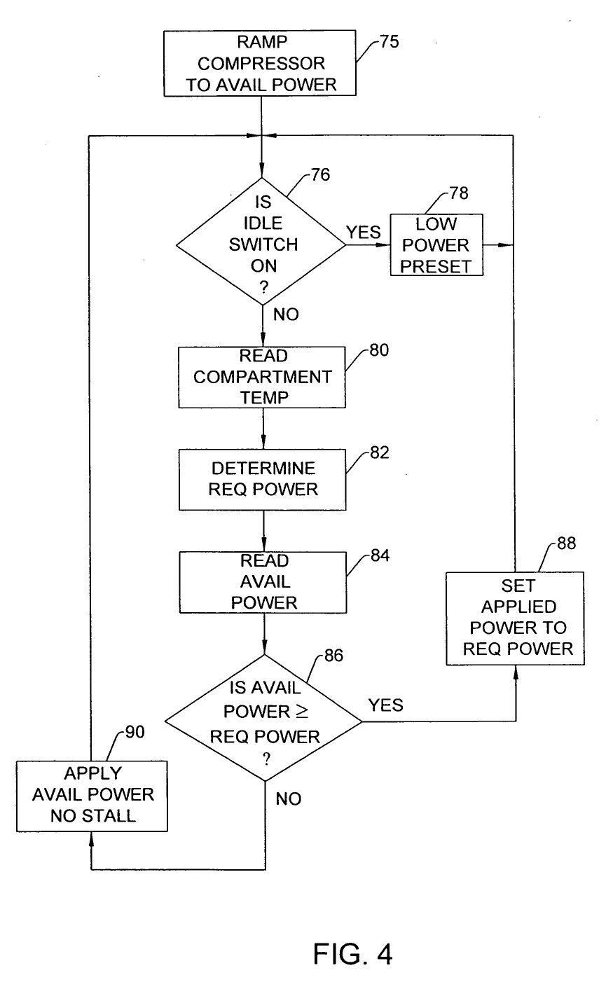

The FIG. 4 diagram illustrates operation of the refrigeration power control arrangement including the optional engine idle switch 64. Refrigeration power system start-up begins at ramping step 75. At step 75, the controller 50 receives the available power value signal 44, and if enough power is available, sends a compressor speed control signal 62 to the speed controller 33 of the variable speed compressor 20 so that the AC compressor motor begins operating toward the low end frequency (40 Hz). As the refrigeration cooling unit 12 requires less power as the storage compartment temperature decreases, the variable speed compressor 20 increases or ramps up in frequency (speed) to provide a greater cooling capacity.

After the compressor 20 is ramped to the available power value, at step 76 the controller 50 senses if the idle switch 64 is on. If the idle switch 64 is on (engine idling) at step 76, the controller 50 advances to step 78 as shown in FIG. 4.

At step 78, the controller 50 provides a power supply signal 54 to enable power switch 56 to provide an available power value to the compressor 20. Further, the controller 50 provides a predetermined low power pre-set value as the compressor control signal 62 to operate the variable speed compressor 20 at a low speed and provide some cooling capacity for the storage compartment 14 without stalling the compressor. Then the controller 50 returns to step 76 and reads whether the idle switch 64 is on, and if so, repeats the step 78.

If the idle switch 64 is not on at step 76, the controller 50 advances to step 80. At step 80, the controller 50 reads the compartment temperature signal 48. At step 82, the controller 50 determines a required power value to obtain/maintain a pre-selected temperature based on the compartment temperature signal 48 and the power in use signal 34 obtained from the power use sensor 32.

At step 84 the controller 50 obtains or reads the available power value signal 44 from the power source sensor 42.

At step 86, the controller 50 determines if the available power value of the available power value signal 44 is greater than the required power value. If so, at step 88 the controller 50 enables power switch 56 to provide power derived from the power source 40 by the inverter 41 to the compressor 20 and provides a compressor speed control signal 62 to the speed controller 33 so that the compressor 20 operates at the required power value. Thus the refrigeration power system obtains or maintains the pre-selected temperature in the storage compartment 14.

After step 88, the controller 50 returns to step 76 to determine if the idle switch 64 is on. If not, the process then repeats the process as shown in FIG. 4.

If the available power value at step 86 is less than the required power value, the controller 50 advances to step 90.

At step 90, the controller 50 controls power switch 56 to provide the available power to the variable speed compressor 20 and sends a compressor speed control signal 62 to operate the refrigeration unit and provide some cooling capacity to the storage compartment 14. If the controller 50, however, senses that the available power value is not sufficient to operate the variable speed compressor 20 at its lowest speed, the controller 50 shuts off power through power switch 56 and/or the controller provides a speed control signal 62 to the speed controller 33 that stops operation of the AC motor of the variable speed compressor 20 and prevents compressor stall. Further, if the controller 50 senses that the power in use signal 34 from the variable speed compressor 20 has a value indicating compressor stall, the controller 50 immediately disables power switch 56 to prevent the input of available power to the compressor and/or sends a compressor speed control signal 62 to the speed controller 33 that stops the compressor 20.

After step 90, the controller 50 returns to step 76 to repeat the control process.

In some embodiments the engine idle switch 64 does not provide an input to the controller 50. In these embodiments, the steps 76, 78 in FIG. 4 are eliminated and the controller 50 simply advances from step 75 to step 80.

The above method enables the controller 50 to provide cooling capacity to maintain the storage compartment 14 at a pre-selected temperature when adequate required power is available and to also provide some cooling at a lower capacity when only enough power for a lesser cooling capacity is available. Thus, the refrigeration power system is capable of providing cooling capacity with a lower amount of available power than a refrigeration system that does not have a variable speed compressor 20 and that is unable to operate at a lower power value. Further, the refrigeration power system also adjusts to provide a greater cooling capacity when additional power is available. Thus, the claimed system provides improved power efficiency compared to the prior art discussed above.

### Second Embodiment

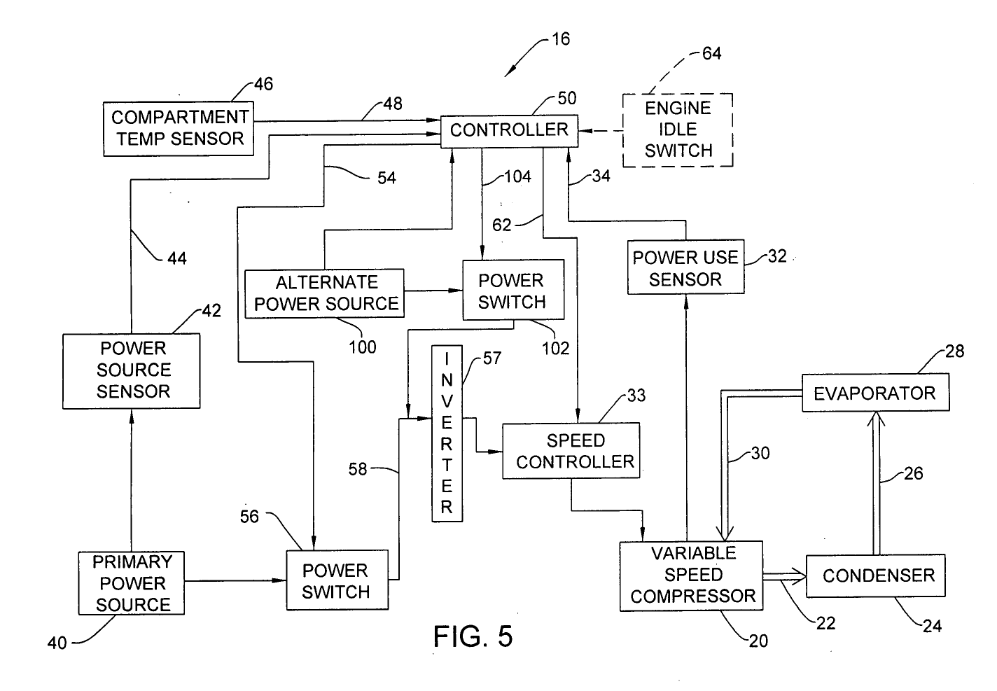

FIG. 5 illustrates a second embodiment of the invention. Reference numerals in this embodiment that correspond to the reference numerals of the first embodiment represent elements that provide the same function. Thus, these elements will not be described in detail herein.

In this embodiment, the power source 40 is a primary power source, an alternate power source 100 is provided, which sends an available power signal to the controller 50. A second power switch 102 connects the alternate power source 100 to the inverter 57, which is shared with the primary power source 40. In some embodiments a second separate inverter is provided for the alternate power source 100.

The controller 50 is capable of providing a power supply signal 104 to operate the second power switch 102. The second power switch 102 is similar to the power switch 56 discussed above. When activated, the power switch 102 sends AC power derived from the alternate power source 100 by inverter 57 to the variable speed compressor 20.

### Operation of Second Embodiment

As shown in FIG. 5, the second embodiment of the invention includes an alternate power source 100 having an available power value that is read by or provided to the controller 50.

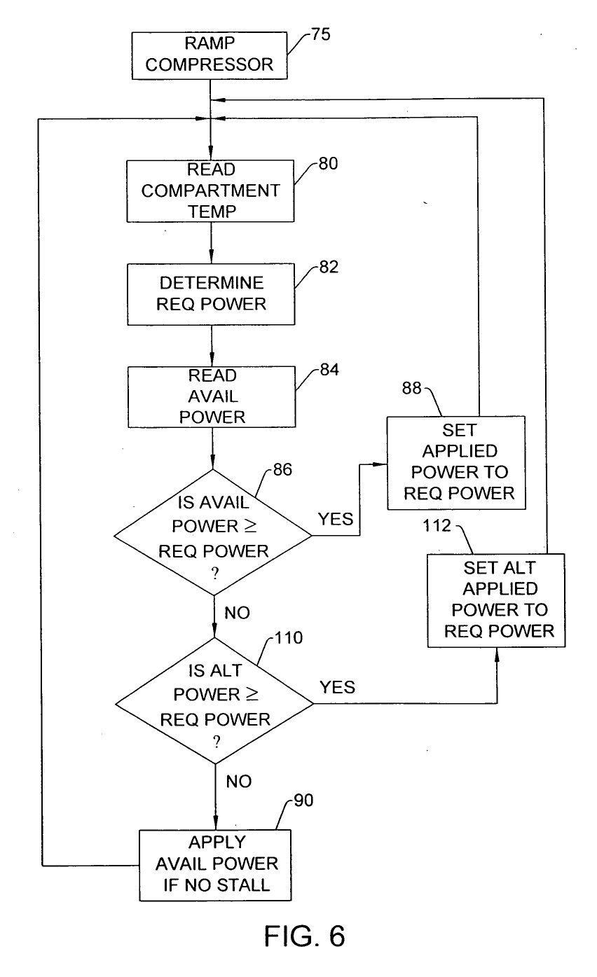

This embodiment of the invention operates in the same manner shown in FIG. 6. Steps wherein the controller operates as in the first embodiment illustrated in FIG. 4, include the same reference numerals. The preferred embodiment does not include the engine idle switch 64.

The compressor 20 is ramped at step 75 as in the first embodiment. FIG. 6 shows steps 80, 82, 84, 86 and 88 whereat the controller 50 operates in generally the same manner as in the embodiment shown in FIG. 4.

One exception is when the available power value is greater than the required power value. The controller provides an additional operation at step 88 shown in FIG. 6. At step 88, the additional power that is not required to drive the variable speed compressor 20, is supplied to charge the alternate power source 100. The controller 50 then returns to step 80.

When the available power value is less than the required power value at step 86, the controller 50 advances to step 110.

At step 110 in FIG. 6, the controller 50 determines if the available power value from the alternate power source 100 is greater than the required power value for the compressor 20. If the available power value from the alternate power source 100 is greater than the required power, the controller advances to step 112.

At step 112, the controller 50 provides a power supply signal 104 to the second power switch 102 to connect the inverter 67 providing AC power derived from the alternate power source 100 to the variable speed compressor 20 and a speed control signal 62 to the speed controller 33. At the same time, the controller 50 disconnects or opens the first power switch 56. The power derived from the alternate power source 100 through the inverter 57 provides the required power value to operate the variable speed compressor 20. In this manner, when the primary power source 40 does not have adequate available power value, the refrigeration power system still obtains or maintains the storage compartment 14 at the pre-selected temperature. In some embodiments, the additional power from the power source 40 is provided to charge the alternate power source 100 while the alternate power source 100 provides power to the compressor 20.

At step 100 in FIG. 6, when the power value of the alternate power source 100 is less than the required power value, the controller advances to step 88. At step 88 the controller 50 provides the available power to provide some cooling and prevent compressor stall.

### Power Sources

In the embodiment of FIG. 2, a single power source 40 is provided. This power source 40 preferably is a vehicle generator. The vehicle generator 40 is connected to a vehicle engine shaft of the vehicle engine via a power take-off or a belt. In another embodiment, the vehicle generator 40 is an alternator that includes a rectifier circuit in order to provide a DC voltage for the refrigeration unit. The power source sensor 42 is a power/load electric sensor 42 connected to the vehicle generator 40 to determine how much excess power from the vehicle generator is available.

The FIG. 2 embodiment can also coact with an shore power source (not shown) that is independent of the vehicle 10. The shore power source connects to a power receiving jack on the vehicle 10 and can provide power to the refrigeration unit 12 when the vehicle generator 40 is not providing power, for example when the vehicle 10 is not in use.

In the embodiment of FIG. 5, the primary power source 40 preferably is the vehicle generator 40. In FIG. 5, the alternate power source 100 can be one or more of a plurality of power sources as follows.

In one embodiment, the alternate power source 100 is a separate battery bank mounted on the vehicle 10. The separate battery bank 100 can be charged by the vehicle generator 40 in certain circumstances as discussed above.

The separate battery bank 100 is capable of connection to and charging by an shore power source when the vehicle 10 is not in use. A power cord connects the shore power source to a power receiving jack on the vehicle. Depending on the rating of the shore power source, the refrigeration power system and the refrigeration unit 12 including the compressor 20, can operate while the battery bank 100 is being charged.

In another embodiment, the power alternate source 100 is a vehicle battery 100 for starting the vehicle engine. The vehicle battery 100 can also be charged by the vehicle generator 40 and/or an shore power supply.

While not discussed above, varying the speed of the variable speed compressor 20, depending on the required cooling capacity, can either enable constant operation of the compressor 20 at a lower cooling capacity than maximum capacity, or reduce the number of times per minute that the compressor 20 must cycle by shutting off and restarting. Eliminating or reducing cycling of the variable speed compressor 20 reduces wear on the compressor components.

In some embodiments, a variable speed compressor 20 begins providing a cooling output at a frequency of about 30 Hz. In other embodiments, the variable speed compressor 20 may begin providing a cooling output at a frequency of about 20 Hz. Finally, in some embodiments the electric motor of the variable speed compressor 20 operates at a maximum frequency of about 90 Hz.

Although particular preferred embodiments of the invention are disclosed in detail for illustrative purposes, it will be recognized that variations or modifications of the disclosed system, including the re-ordering of method steps, is within the scope of the present invention.

What is claimed is:

1. A refrigeration power system for a refrigeration unit including a variable speed compressor, a condenser and an evaporator, for use with a vehicle having a storage compartment and a vehicle battery comprising:
a power use sensor for sensing a compressor power value representing the amount of electric power being used to drive the compressor;
an electric power source capable of providing varying amounts of power;
a power source sensor for sensing an available electric power value for the power source;
a temperature sensor for measuring a storage compartment temperature in a storage compartment; and
a controller configured to receive the storage compartment temperature from said temperature sensor and the compressor power value from said power use sensor to determine a required power value for obtaining or maintaining the storage compartment at a pre-selected temperature, said controller configured for comparing the available electric power value with the required power value for varying the speed of the variable speed compressor to maximize cooling capacity of the refrigeration unit and to prevent compressor stall.

2. The refrigeration power system of claim 1,
wherein said controller is configured for determining when the available electric power value is greater than the required power value and for providing a compressor speed control signal to a speed controller of the variable speed compressor for operating a compressor motor at a speed that obtains or maintains a storage compartment at the pre-selected temperature; and said controller is configured for determining when the available electric power value is less than the required power value and for providing a compressor speed control signal to the compressor for enabling operation of the compressor motor to provide some amount of cooling to a storage compartment while avoiding compressor stall.

3. The refrigeration power system of claim 1, wherein the refrigeration power system includes a power cord for connecting an electrical outlet to provide off-shore electrical power to the refrigeration unit.

4. The refrigeration power system of claim 1, wherein the power source comprises a primary power source and the power system further comprises: an alternate electric power source for mounting in the vehicle for receiving and storing excess power from the primary power source that is not required for the refrigeration unit so that, when the required power value is greater than the available electric power value of the primary power source and said alternate power source is at an adequate charge, said controller is configured for replacing the available power value from the primary power source by providing the required power value from said alternate power source to said variable speed compressor to obtain or maintain the storage compartment at the pre-selected temperature and avoid compressor stall.

5. The refrigeration power system of claim 4, wherein the alternate power source comprises a battery bank for mounting on the vehicle.

6. The refrigeration power system of claim 1, wherein the power source comprises a vehicle generator that is driven by a belt connected to an output shaft of a vehicle engine and the available electric power value corresponds to available electric energy from the vehicle generator, and said power source sensor comprises an engine power/load sensor device for sensing the power and load on the vehicle generator to determine the available electric power value for the vehicle generator.

7. The refrigeration power system of claim 6, said refrigeration power system further comprising an idle switch for determining an idle condition for a vehicle engine, wherein, in response to detection of engine idling, said controller is configured for setting the available electric power value to a predetermined preset power value for maintaining some cooling capacity for the refrigeration unit while avoiding compressor stall.

8. The refrigeration power system of claim 1, wherein the variable speed compressor operates in a frequency range of about 30 Hz to about 60 Hz.

9. A method for controlling a refrigeration unit for cooling a storage compartment in a vehicle, the refrigeration unit comprising a variable speed compressor, a condenser and an evaporator, the compressor being powered by an electric power source, the method comprising the steps of:
sensing electrical power of the electric power source, and determining an available electric power value;
measuring the temperature of a storage compartment;
sensing a power in use value for the variable speed compressor;
determining from the storage compartment temperature and the compressor power in use value a required power value for obtaining or maintaining a storage compartment at a pre-selected temperature; and
comparing the available electric power value with the required power value to vary the speed of the variable speed compressor to maximize cooling capacity of the refrigeration unit and prevent compressor stall.

10. The method of claim 9, wherein the comparing step to maximize cooling comprises the steps of:
when the available electric power value is greater than the required power value, providing the required power value to power the variable speed compressor of the refrigeration unit to obtain or maintain the storage compartment at the pre-selected temperature; and
when the available electric power value is less than the required power value, providing the available electric power value to power the variable speed compressor and provide some amount of cooling to a storage compartment that is less than a desired amount of cooling to maintain a storage compartment at the pre-selected temperature and avoid compressor stall,
wherein as the refrigeration unit efficiency increases, the required power value needed to drive the compressor and maintain the pre-selected temperature decreases.

11. The method of claim 9, wherein the power source comprises the vehicle generator driven by the vehicle engine and the available electric power value is electrical energy provided by the generator and not needed to operate the vehicle.

12. The method of claim 11, including the steps of:
sensing an idle condition for the vehicle engine; and setting the available electric power value to a predetermined preset power value in order to provide some amount of cooling and prevent compressor stall in response to an idle condition.

13. The method of claim 9, including an alternate power source for the refrigeration unit, the power source comprising a primary power source, the method including the steps of:
charging the alternate power source from the primary power source when the controller senses excess power from the primary power source not required by the variable speed compressor; and
when the available electric power value from the primary power source is less than the required power value for operating the refrigeration unit, sending power corresponding to the required power value from the alternate power source to the variable speed compressor and disconnecting the primary power source to maintain the storage compartment at the pre-selected temperature or to prevent compressor stall.

14. A refrigeration power system for powering a refrigeration unit combined with a vehicle having a vehicle battery comprising:
a storage compartment;
a variable speed compressor having a compressor motor;
a condenser having an input port connected to an output port of said variable speed compressor;
an evaporator having an input port connected to an output port of said condenser, said evaporator having an output port connected to an input port of said compressor;
an electric power source capable of providing varying amounts of power;
a power source sensor for sensing an available electric power value for the power source;
a power use sensor for providing a compressor power in use signal having a power in use value representing the amount of electric power driving said compressor;
a temperature sensor for measuring storage compartment temperature in the storage compartment; and
a controller configured to receive the storage compartment temperature from said temperature sensor and the power in use value from said compressor for determining a required power value to obtain or maintain the storage compartment at a pre-selected temperature, and said controller configured for comparing the available electric power value for cooling with the required power value to vary the speed of said compressor to maximize cooling capacity of the refrigeration unit and for preventing compressor stall.

15. The refrigeration unit of claim 14, wherein said power source comprises a vehicle generator driven by a power take-off or a belt connected to an output shaft of a vehicle engine and the available electric power value corresponds to available electric energy from said vehicle generator, and said power source sensor comprises an engine power/load sensor device for sensing the power and load on the vehicle engine to provide the available electric power value for said vehicle generator.

16. The refrigeration unit of claim 15, said refrigeration unit further comprising an idle switch for determining an idle condition for the vehicle engine, wherein, in response to detection of engine idling, said controller sets the available electric power value to a predetermined preset power value that maintains operation of the variable speed compressor to provide some cooling while avoiding compressor stall.

17. The refrigeration unit of claim 14,
wherein, when the available electric power value is greater than the required power value, the controller is configured for providing a compressor speed control signal to operate the compressor at a speed that obtains or maintains the storage compartment at the pre-selected temperature, and when the available electric power value is less than the required power value, said controller is configured for providing the available electric power to said compressor to provide some amount of cooling for the storage compartment without compressor stall.

18. The refrigeration unit of claim 14, wherein said power source comprises a primary power source and the refrigeration unit further comprises:
an alternate power source in the vehicle for receiving and storing excess power from said primary power source when power is not needed for the refrigeration unit so that, when the required power value is greater than the available electric power value and said alternate power source is at an adequate charge, said controller is configured for disconnecting said primary power source and providing stored available power equal to the required power value from said alternate power source to said variable speed compressor to obtain or maintain the storage compartment at the pre-selected temperature and avoid compressor stall.

19. The refrigeration unit of claim 18, wherein said primary source comprises a vehicle generator and said alternate power source comprises one of a battery bank and a vehicle battery that provides starting power to start the vehicle engine.

20. The refrigeration unit of claim 14, wherein the storage compartment of the vehicle has a volume of at least 400 cubic feet.
